(19) United States
(12) Patent Application Publication
(10) Pub. No.: US 2016/0039093 A1
(43) Pub. Date: Feb. 11, 2016

(54) LOW-IMPEDANCE ARTICULATED DEVICE AND METHOD FOR ASSISTING A MANUAL ASSEMBLY TASK

(71) Applicants: GM GLOBAL TECHNOLOGY OPERATIONS LLC, Detroit, MI (US); Universite Laval, Quebec (CA)

(72) Inventors: Muhammad E. Abdallah, Rochester Hills, MI (US); Dalong Gao, Rochester, MI (US); Clement Gosselin, Quebec (CA); Jacques Hache, Quebec (CA); Pascal Labrecque, Quebec (CA); Jianying Shi, Oakland Township, MI (US)

(73) Assignees: UNIVERSITE LAVAL, Quebec (CA); GM GLOBAL TECHNOLOGY OPERATIONS LLC, Detroit, MI (US)

(21) Appl. No.: 14/811,072

(22) Filed: Jul. 28, 2015

Related U.S. Application Data
(60) Provisional application No. 62/035,014, filed on Aug. 8, 2014.

(51) Int. Cl. B25J 9/16; B25J 13/00; B25J 9/04

(52) U.S. Cl. CPC B25J 9/1687; B25J 9/1615; B25J 9/046; B25J 13/00; Y10S 901/09

(57) ABSTRACT

A system for assisting an operator in a manual assembly task includes a base assembly, end-effector, and controller. The base assembly has joint actuators providing three or more degrees of freedom (DOF). The end-effector is in series with the base assembly and has additional joints providing one or more additional DOFs. The base assembly and end-effector support a task load, including a weight and/or a reaction torque of an object. Sensors measure joint positions. The controller receives the measured positions, controls the joint actuators to support the task load, and extends a range of motion of the object. A method includes receiving the position signals as the operator manipulates the object, generating an output signal using the measured positions, and transmitting the output signal to the joint actuators to control the joint actuators, support the task load, and extending a range of motion of the object.

### CROSS-REFERENCE TO RELATED APPLICATIONS

This application claims the benefit of U.S. Provisional Application No. 62/035,014, filed on Aug. 8, 2014, which is hereby incorporated by reference in its entirety.

### TECHNICAL FIELD

The present disclosure relates to a system and method of using a low-impedance articulated device for assisting an operator in the performance of manual assembly tasks.

### BACKGROUND

The force and torque task load of a given manual assembly task varies with the particular task that is being performed. For example, certain manufacturing or assembly steps require a human operator to use a handheld power tool, such as an electric torque wrench or nut driver, to tighten a series of fasteners. The operator typically has to support the full weight of the tool, locate the individual fasteners, and provide the required reaction torque as the fasteners are tightened. The fasteners may be difficult to access in an ergonomically conducive manner while the operator bears the brunt of the task load. Another example manual task is the placement and installation of a pane of glass into a door panel. Task loads experienced during such a task include grasping, transporting, and rotating the glass pane into position while bearing its weight. Material handling, product assembly, and other manufacturing/assembly tasks likewise can present unique task loads that are borne primarily by the operator.

### SUMMARY

A system includes a support structure and an articulated device, the latter of which includes a base assembly, an end-effector, and a controller. The articulated device is designed to assist an operator in the execution of a manual assembly task. The base assembly, which is connected to the support structure such as a gantry or overhead crane, has a plurality of joints and joint actuators collectively providing the articulated device with at least three degrees of freedom (DOF). The end-effector is configured to grasp an object such as a work tool or work piece, is connected in series with the base assembly, and has one or more additional joints providing the device with at least one additional DOF. The base assembly and end-effector are configured to support a task load, such as a weight or a reaction torque of a work tool. The system includes sensors operable for measuring a position of a corresponding one of the joints.

At least some DOF of the end-effector are redundant with the base assembly, with the redundant DOF being the particular DOF within which an operator requires a large range of motion. The term “redundant DOF” as used herein means that motion of the work tool can be achieved either by the base assembly or the end-effector in such redundant DOF. Redundancy allows the system to function properly, i.e., by ensuring that the base assembly prevents the end-effector from hitting joint limits while in the redundant DOFs, which in turn allows the operator to perceive only the impedance of the end-effector.

The controller is programmed to receive the measured positions from the sensors, generate a control output signal using the received measured positions, and transmit the control output signal to the joint actuators to thereby control the joint actuators in a manner sufficient for supporting the task load and for extending a range of motion of the work tool with respect to the end-effector.

The robotic assist device described herein may be suspended from or otherwise supported by the gantry, which in turn has one or two translational degrees of freedom, with such translational degrees of freedom being part of the total number of available degrees of freedom of the articulated device. The base assembly may include such a support structure, the support structure may be alternatively embodied as any robot having the requisite degrees of freedom (DOF), e.g., a conventional 6 axis/6 DOF universal manufacturing robot.

The articulated device is configured as a serial robotic mechanism having an actively-controlled base assembly and a passively-controlled and/or actively-controlled end-effector, with “actively-controlled” meaning an actuator-driven joint and “manually-controlled” meaning manually adjusted, as is well known in the art. The device is designed to reduce or eliminate, from the perspective of the operator, a targeted task-specific load for a given manual task, such as the weight and/or torque of a relatively bulky handheld tool. The end-effector in turn is designed to offer minimal impedance, e.g., minimal inertia and friction, and to provide all of the necessary DOF for local or fine manipulation of the grasped/supported tool. Hence, only the end-effector is required for fine motion or manipulation by the operator, and thus the operator experiences only minimal interference in executing dexterous portions of the manual assembly task.

The capability described above allows the operator to focus on relatively high dexterity or fine motion activities such as locating and mating of components in an assembly task. To achieve the desired ends, select joints/DOF of the device are actuated via joint actuators in the form of motors, linear actuators, or the like in response to feedback, e.g., position signals or other suitable data from joint position sensors, and are thus actively driven or controlled. The controller offloads or supports non-dexterous task loads of the manual assembly task, for instance static or reactive loads. If desired, the controller can maintain an equilibrium position of the end-effector. The present design may enable manual assembly as an option for performing some tasks that are traditionally automated, while also allowing reconfigurable/modular end-effector designs to be used with the base assembly. Associated control modes may be selected by the operator via the controller as set forth herein.

The present design may utilize a passive version of the end-effector. In such an embodiment, the device may have at least six DOF, i.e., three passive DOF in the end-effector and another three active DOF in the base assembly. Two additional DOF of the end-effector, passive and/or active, are required if rotational orienting of the work tool is desired. The end-effector can be used along with interactions by the operator to drive the base assembly. As a result, low-impedance is achieved from the perspective of the operator with respect to moving the work tool, workpiece, or other grasped object.

Control may be according to a task-specific control law, e.g., position control, impedance control, admittance control, and/or force amplification as are known in the art. A human-machine interface (HMI) in communication with the controller may be used to allow the operator to select a particular task, control mode, and associated control law. For instance, an operator could select a control sequence of “select a pane of glass, latch onto the glass, move the latched pane to a door panel, and unlatch”, with the particular control law corresponding to the control sequence. For force-intensive operations such as inserting a spark plug, the control law could include force amplification, such that the actuated joints amplify an applied force or torque from the operator to reduce the load on the operator. Actuated joints can be controlled in an autonomous mode where they perform pre-programmed tasks independent of the operator in order to reduce the non-value added effort of the operator.

The end-effector may have five DOF, with one or more DOF being optionally constrained in some embodiments. The end-effector may be constructed of a lattice of lightweight materials such as plastic, aluminum, or composite materials in an example configuration. An operator selectively positions the end-effector as desired in the execution of the work task. The programmed functionality of the controller moves the base joints to keep the end-effector in its joint limits. The operator thus only perceives the impendence of the end-effector and not that of the base assembly. The task load is supported either passively by the structure or actively by the actuated joints. Passive and active versions of the end-effector may be alternatively envisioned to allow any constrained DOF to help resist the task load and thus provide an opportunity for force amplification as explained herein.

The base assembly and end-effector may be statically balanced in some embodiments such that the end-effector remains in a particular equilibrium position when the work tool is released by the operator.

A method for assisting an operator in the performance of a manual assembly task involving an object, e.g., a work tool or work piece. The method includes receiving measured position signals from the sensors as the operator manually manipulates the object, with the measured position signals being indicative of the measured positions. Additionally, the method includes generating a control output signal using the received measured positions and transmitting the control output signal to the joint actuators to thereby control the joint actuators. Control of the joint actuators is performed in a manner sufficient for supporting the task load and extending a range of motion of the object with respect to the end-effector.

The above and other features and advantages of the present disclosure will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic side view illustration of a system having a low-impedance articulated device suitable for assisting an operator in the performance of a manual assembly task.

FIG. 1A is another schematic side view illustration of the system shown in FIG. 1.

FIG. 2 is a schematic perspective view illustration of the articulated device of the system shown in FIGS. 1 and 1A.

FIG. 3 is another schematic perspective view illustration of the articulated device shown in FIG. 2.

FIG. 4 is a flow chart describing an embodiment of a control method usable with the system and device shown in FIGS. 1-3.

### DETAILED DESCRIPTION

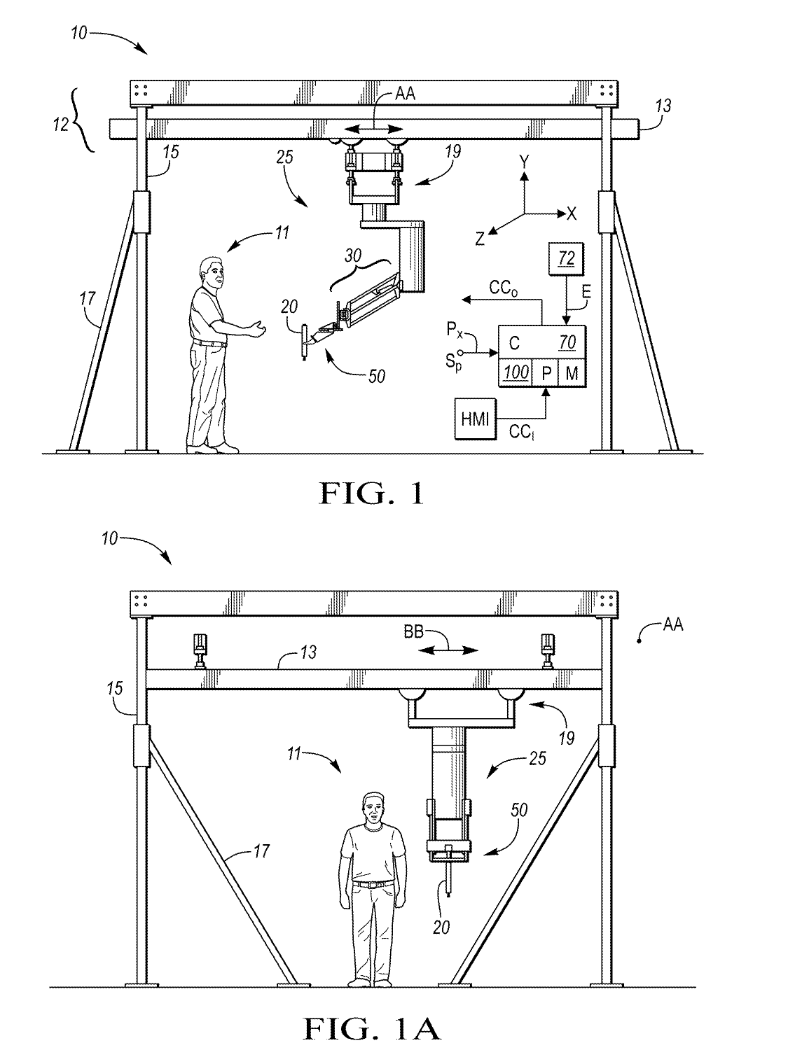

Referring to the drawings, wherein like reference numbers refer to like components, a system 10 is shown in FIG. 1 that includes an articulated device 25. The device 25, which includes a base assembly 30, an end-effector 50, and a controller (C) 70, is a low-impedance, articulated robotic serial mechanism that is specially configured to assist a human operator 11 in the performance of a manual assembly task, which encompasses any work task requiring the lifting, supporting, and/or positioning of an object such as an example work tool 20, or alternatively a work piece moved and assembled with respect to another component or part. The device 25 described herein has two primary functions: (1) to reduce or eliminate targeted task loads needed for completing the manual assembly task, and (2) to allow the operator 11 to manipulate the work tool 20 with a low impedance level perceived by the operator 11. For simplicity, the object being acted on will be described hereinafter as a work tool 20 without limiting the object to such an embodiment. That is, the term “work tool” may apply broadly to any grasped or supported object, including but not limited to work pieces such as sheets of metal, panes of glass, other types of work tools, components, and the like.

To achieve the first goal of a reduced task load, both the base assembly 30 and the end-effector 50 are arranged in series to support the task load, such as the weight or reaction torque of the work tool 20. Low perceived impedance is achieved due to the operator 11 only having to push or move the relatively small/lightweight end-effector 50 rather than the entire base assembly 30 in the conventional manner or robotic smart arms. The larger base assembly 30 is nevertheless configured to expand the range of motion of the end-effector 50, and thus of the work tool 20, relative to smart arm designs and other designs that are not constructed as claimed.

The system 10 of FIG. 1 may include a support structure 12 having an active/actuated linear positioning mechanism of the type known in the art, e.g., a two degree of freedom (DOF) gantry or overhead bridge crane having a suspended trolley 19 as shown. While described as a separate structural element herein, the suspended trolley 19 of the support structure 12, or at least the translational DOF of the suspended trolley 19 as provided by the support structure 12, are considered to be part of the base assembly 30. That is, the two translational DOF of the suspended trolley 19 are controlled by operation of the controller 70 along with the translational and rotational DOF of the base assembly 30 in performing steps of an associated method 100, such that the base assembly 30 is considered herein to include any structural elements providing the translational DOF of the example support structure 12.

The support structure 12 in the example embodiment of FIGS. 1 and 1A may include one or more horizontal rails 13, vertical support beams 15, and angled support beams 17. The terms “horizontal”, “vertical”, and “angled” as used herein refer to typical orientations with respect to the operator 11 in a typical Cartesian reference frame. The vertical support beams 15 and the angled support beams 17 together support the weight of the horizontal rails 13 from below as shown. The suspended trolley 19 is actuated via motors, chains, belts, and/or the like (not shown) so that the trolley 19 is able to translate along the horizontal rails 13 as indicated by double-headed arrow AA.

The same trolley 19 may, in some embodiments, be able to translate orthogonally with respect to the horizontal rails 13 as indicated by the double-headed arrow BB in FIG. 1A. Such motion may be possible by moving the trolley 19 and/or by moving the horizontal rails 13. Structure and function of overhead bridge cranes are well known in the art, and thus their details are omitted for illustrative simplicity. As noted above, however, the support structure 12 of FIGS. 1 and 1A is merely one possible configuration, as the base assembly 30 may be embodied as any robot having the requisite DOF described below, e.g., a 6 axis/6 DOF universal manufacturing robot.

In FIGS. 1 and 1A, the manual task is an example installation of a nut or other fastener via the work tool 20, such as when the work tool 20 is configured as a cylindrical electric nut driver or power torque wrench as shown, although other manual tasks and other work tools 20 may be envisioned. The example work tool 20 shown in FIGS. 1 and 1A will be used hereinafter for illustrative consistency.

As noted above, the system 10 includes a controller 70. The controller 70 may be embodied as one or more digital computers having a processor (P) and memory (M), and may include or be in communication with a database 72. As noted below with respect to FIG. 4, the database 72 may include kinematic equations (arrow E) which are uploaded into memory (M) as needed at certain parts of the method 100. The memory (M) includes sufficient amounts of tangible, non-transitory memory, e.g., read only memory, flash memory, optical and/or magnetic memory, electrically-programmable read only memory, and the like. Memory (M) also includes sufficient transient memory such as random access memory and electronic buffers. Hardware of the controller 70 may include a high-speed clock, analog-to-digital and digital-to-analog circuitry, and input/output circuitry and devices, as well as appropriate signal conditioning and buffer circuitry.

The controller 70 may also include or be in communication with a human machine interface (HMI) such as a touch-sensitive display screen to facilitate selection of different control modes in the execution of the method 100, an example of which is shown in FIG. 4 and described below. As part of the overall control of the device 25, the controller 70 may receive position signals (arrow P_{X}) from one or more joint position sensors (S_{P}) positioned with respect to joint actuators of the device 25, i.e., any passive or active joints. In this manner, the controller 70 is able to use position feedback of the type known in the art in the overall control of the device 25. Additional control inputs (arrow CC_{I}) are received by the controller 70 from the HMI, such as selections of a particular task and/or preferred control mode by the operator 11. Control output signals (arrow CC_{O}) are then transmitted by the controller 70 to the various joint actuators so as to maintain a desired relative positioning of the various passive joints of the device 25.

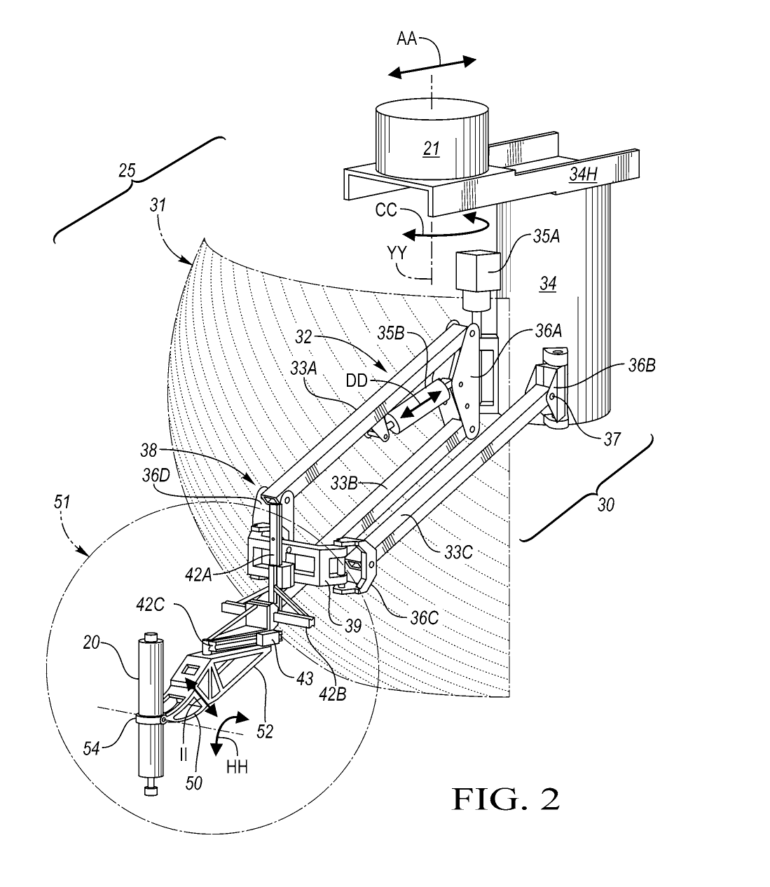

Referring to FIG. 2, the device 25 is shown in a possible embodiment with an example design of the base assembly 30 and end-effector 50. The end-effector 50 is operatively connected to the base assembly 30. The end-effector 50 of FIG. 2 is shown in just one possible example configuration, in this case embodied as a lightweight modular/replaceable latticed design suitable for grasping the work tool 20 when the work tool 20 is in the form of an example cylindrical electric torque wrench. The base assembly 30 is controlled via the control output signals (arrow CC_{O} of FIG. 1A) from the controller 70 of FIG. 1 according to position and/or force feedback from the end-effector 50, which is true in all disclosed embodiments.

For example, the base assembly 30 is designed to move in a manner that keeps the end-effector 50 in desired portion of its allowable range of motion, generally indicated via circle 51, such as at an equilibrium position. This is possible because a corresponding range of motion 31 of the base assembly 30 is larger than the possible range of motion 51 of the end-effector 50. Thus, the operator 11 of FIGS. 1 and 1A may finely position or manipulate the work tool 20 while only perceiving the impedance of the much lighter end-effector 50, all while enjoying the larger range of motion 31 afforded by the base assembly 30. The base assembly 30 may be controlled to support most or all of the weight of the end-effector 50 such that the end-effector 50 is perceived as having low impedance, i.e., appears to the operator 11 to be essentially weightless in the manner described above.

The base assembly 30 in the example embodiment of FIG. 2 includes a frame 32 having, in an embodiment, the basic form and function of a double parallelogram mechanism. As is well known in the art, a double parallelogram mechanism provides translation without rotation of a structure connected to a distal end 38 of the frame 32, in this instance vertical translation with respect to the Y axis in an XYZ Cartesian frame of reference. The frame 32 may include first, second, and third control arms 33A, 33B, 33C, respectively, forming the double parallelogram mechanism noted above, although additional control arms could be used to increase strength. Likewise, only two of the control arms 33A, 33B, 33C could be used in other embodiments. However, if only control arms 33A and 33B are used, the mechanism will be a single parallelogram mechanism.

The frame 32 of FIG. 2 is connected to a vertically-oriented control cylinder 34, again with vertical orientation taken with respect to the normal standing orientation of the operator 11 of FIG. 1, within which is positioned or to which is connected a first joint actuator 35A. Some of the structure of the first joint actuator 35A, including any electrical leads or power control equipment, may be housed within the control cylinder 34 and is thus not depicted in FIG. 2. The first joint actuator 35A may be an electric motor or other rotational actuator that enables the frame 32 to rotate with respect to the cylinder 34, or to rotate the cylinder 34 such that the frame 32 rotates as indicated by double-headed arrow CC. The control cylinder 34 may be connected to a horizontal beam 34H. The cylinder 34 and the horizontal beam 34H thus form a unitary assembly that can rotate around axis YY, i.e., the vertical axis of the Cartesian frame of reference noted above.

A second joint actuator 35B, shown here as an example piston/cylinder, is connected to the frame 32, such as to the underside of the first control arm 33A, and provides vertical translation of the frame 32, i.e., up/down motion of the frame 32 with respect to the control cylinder 34. Control of the first and second joint actuators 35A, 35B via the control output signals (arrow CC_{O} of FIG. 1) from the controller 70 ultimately maintains or controls the position of the end-effector 50 via motion of the base assembly 30, with the DOF of the base assembly 30 always active/actuated. The base assembly 30 as shown in FIG. 2 has a total of three DOF as indicated by double-headed arrows AA, BB, and CC. However, translational motion in the vertical direction could be included for a total of four DOF without departing from the intended inventive scope. Double-headed arrow DD in FIG. 2 indicates that the actuation of the second joint actuator 35B produces vertical translation of end-effector 50.

The frame 32 of FIG. 2 may include a primary brace 36A and a secondary brace 36B, with the braces 36A and 36B connected to the control cylinder 34. In the embodiment shown, the first and second control arms 33A and 33B are arranged in parallel with each other and connected, via a respective pin 37, to the primary brace 36A so as to form an actively-controlled control arm of the frame 32. The second actuator 35B may be a piston or other linear actuator that is pivotally secured to the first control arm 33A and the primary brace 36A, with the term “upper” being with respect to the horizontal or ground as viewed by the operator 11 of FIGS. 1 and 1A. The third control arm 33C is pivotally secured to the secondary brace 36B via another pin 37.

The distal ends 38 of the first and second control arms 33A and 33B in FIG. 2 are connected to an additional brace 36D as shown, while the distal end 38 of the third control arm 33C is connected to an additional brace 36C such that a type of double parallelogram mechanism is formed. An end bracket 39 may be disposed at the distal ends 38 and connected to the additional braces 36C and 36D to maintain alignment of the control arms 33A, 33B, and 33C and maintain separation therebetween. The end bracket 39 may be embodied as a trapezoidal member as shown having a hinge 40 and hinge pin 41. Motion of the frame 32 translates the end bracket 39 linearly in an up and down/vertical manner.

In the example embodiment shown in FIG. 2, the end-effector 50 may be manually or automatically translated with respect to the base assembly 30 via movement of a slotted carriage 43 along respective first, second, and third linear guide members 42A, 42B, and 42C. The first linear guide member 42A may be vertically oriented and the second linear guide member 42B may be horizontally oriented, i.e., orthogonally arranged with respect to the first linear guide member 42B. The third linear guide member 42C may be arranged non-orthogonally with respect to the second linear guide member 42B. Each linear guide member 42A, 42B, and 42C is received within a mating notch or slot of a respective slotted carriage 43 such that the operator 11 of FIGS. 1 and 1A is able to manually translate the end-effector 50 in three directions with respect to the base assembly 30. The slotted carriage 43 may be designed such that release of the slotted carriage 43 is sufficient to lock the slotted carriage 43 and a corresponding portion of the end-effector 50 in place at a desired position.

In addition to the three translational DOF described above, the end effector 50 of FIG. 2 also includes first and second rotatable joints, with rotation of these joints indicated via double-headed arrows HH and II to show two rotational DOF. The end-effector 50 can resist a torque applied to the tool 20 if the axis around which such a torque is applied does not align with either of the axes about which rotation (double-headed arrows HH and II) occurs. Each DOF of the end-effector 50 may have an accompanying joint position sensor S_{P} (see FIG. 1), omitted from FIG. 2 for clarity, to enable control feedback functionality. That is, position sensor S_{P} may be positioned at each translatable and rotatable joint of the end-effector 50 to measure the joint position and communicate the measured position to the controller 70 of FIG. 1. The controller 70 receives the measured positions (arrow P_{X} of FIG. 1) and uses this information in controlling the motion of the base assembly 30 according to the method 100.

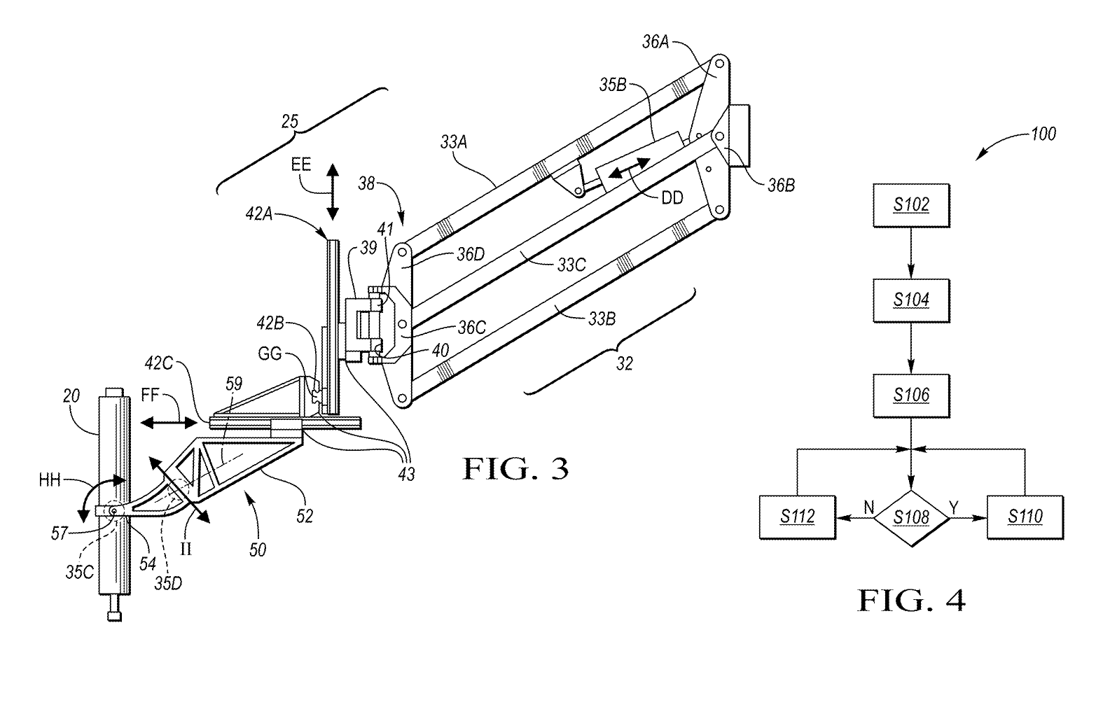

Referring to FIG. 3, the end-effector 50 is shown disposed at the distal end 38 of the frame 32 described above. The end-effector 50 may be embodied as any lightweight structure or device, passive and/or active in terms of its control, and configured to securely grasp the work tool 20 or other object. For instance, the end-effector 50 may be constructed of a lattice 52 of a lightweight task-appropriate material such as plastic, aluminum, or a composite material and equipped with a gripper 54 suitable for grasping the work tool 20. The design of the lattice 52 and of the gripper 54 may vary with the design of the work tool 20 to be used for a given work task.

The end-effector 50 may be modular and thus easily connected or disconnected to/from the base assembly 30. For instance, if using a torque wrench as the work tool 20, a design similar to that of FIGS. 2 and 3 may be used. When changing over to another work task such as gripping and placing a pane of glass in the assembly of a door, the end-effector 50 may be quickly disconnected from the base assembly 30 and replaced with another end-effector 50 having a task-suitable design, e.g., with adjustable or fixed linkages on which are disposed suction cups or rubberized fingers capable of gripping the pane of glass.

Various degrees of freedom (DOF) of the base assembly 30 and end-effector 50 are visible from the perspective of FIG. 3. The translational DOF are provided via the three translatable slotted carriages 43. Two additional rotational DOF are provided along axes 57 and 59 as indicated by double-headed arrows HH and II, respectively. Linear translation of a respective carriage 43 along second linear guide member 42B and 42C is along axes GG and FF, respectively. The various joints of the end-effector 50 may be passively actuated as in the example of FIGS. 2 and 3. However, some of the DOF of the end-effector 50 may be actuated, i.e., providing active versus passive DOF depending on the embodiment. Additional joint actuators 35C and 35D are shown with respect to axes 57 and 59. One or both additional joint actuators 35C and 35D may be used depending on the embodiment. Different combinations of DOF, and/or different combinations of passive versus active DOF, can be envisioned within the scope of the design. The end-effector 50 may be balanced and/or may include light springs or clamps so as to hold the work tool 20 securely in place whenever the operator 11 is not holding the work tool 20. The end-effector may also have elective brakes to lock, for example, in response to the pressing of a button (not shown).

An example method 100 is shown in FIG. 4 that is usable with the articulated device 25 described above. The method 100 is intended for tasks in which the end-effector 50 is passive, although the method 100 may be extended to other variants. Variants of the method 100 may be readily envisioned for different designs, and therefore FIG. 4 shows just one possible programmable option for use with the system 10 of FIGS. 1 and 1A.

Step S102 of method 100 includes recording an assembly task into the controller 70 via the HMI of FIG. 1 such that the controller 70 receives or otherwise determines the work task to be performed. Step S102 may also include identifying a particular end-effector 50 to be used for accomplishing the task. For example, when installing nuts via the tool 20 shown in FIGS. 1-3, an end-effector 50 such as is shown in the various Figures may be used.

The controller 70 thus receives the requested work task via the HMI and identifies the end-effector 50 as part of step S102. As each end-effector 50 has its own unique kinematics, execution of step S102 may include uploading kinematic equations (arrow E) for the selected end-effector 50, e.g., from database 72, into memory (M). As part of step S102 the controller 70 may also determine the initial position of the end-effector 50 in a three-dimensional space. For instance, the operator 11 of FIGS. 1 and 1A may initially position the device 25 via control of the suspended trolley 19 such that the trolley 19 moves along the horizontal rail 13 shown in FIGS. 1 and 1A to a desired initial position. The operator 11 can then select an end-effector 50 and connect it to the base assembly 30. Hardware such as RFID tags or sensors (not shown) may be used to ensure that the end-effector 50 that is installed is appropriate for the previously selected task to be performed, e.g., by a simple match of the end-effector 50 to the selected work task. The controller 70 may be optionally programmed to disable use of the device 25 in the event an inappropriately configured end-effector 50 is connected to the base assembly 30 at the start of an assembly process for a different task, e.g., if a torque wrench is installed and placement of a pane of glass is selected. The method 100 then proceeds to step S104.

At step S104, after selecting the task/end-effector 50 and initially positioning the device 25 at step S102, the operator 11 may, depending on the selected task, select from a list of special control options, each of which may correspond to a particular control law or set laws. Such control laws may include position control, impedance control, admittance control, force control, etc. If the end-effector 50 has one or more active joints, step S104 may entail selecting force or torque amplification to assist in the performance of the task. For instance, the operator 11 may, within a calibrated range, request that a given force multiplier be applied to any force or torque that is input at a selected joint so as to reduce the task load at that particular joint.

In a non-limiting illustrative example, if 10 Nm of torque is required along the axis 57 shown on the work tool 20 in FIG. 3, the operator 11 may request 1.25× force amplification such that an input force of only 8 Nm is required. The available range of multiplication will, of course, depend on the particular actuators used at each joint. Such an option would require force or load sensors at the active joints, with such sensors omitted for illustrative simplicity. The method 100 then proceeds to step S106.

Step S106 includes receiving the measured position signals (arrow P_{X} of FIG. 1) and/or other input signals (arrow CC_{I} of FIG. 1) via the controller 70 as the operator 11 manually manipulates the work tool 20. This step may entail processing position signals from position sensors (S_{P} of FIG. 1) distributed at the various DOF of the device 25 and tracking the changing position in 3D space. The method 100 then proceeds to step S108.

At step S108, the controller 70 next determines whether the signals from step S106 indicate that the operator 11 has moved the end-effector 50 from the initial position to a different position. If so, the method 100 proceeds to step S110. Otherwise the method 100 proceeds to step S112.

At step S110, the controller 70 transmits the output signal (arrow CC_{O}) to the joint actuators 35A, 35B to cause an offset or offloading of the task load during such a movement of the end-effector 50. The result of step S110 is that the impedance perceived by the operator 11 during the movement is very low, and the perceived weight is that of the lightweight end-effector 50 alone. The method 100 then repeats step S106, with the entire method 100 resuming with step S102 when the operator 11 is finished with the task and begins a new one.

Step S112 includes transmitting the output signal (arrow CC_{O}) to the joint actuators 35A, 35B so as to maintain the end-effector 50 at a desired equilibrium or balanced position as the operator 11 performs the work task. The base assembly 30 may move as part of step S112 in response to the output signals (arrow CC_{O}) so as to maintain the end-effector 50 at a middle or other desired point of its calibrated range of motion. As with step S110, the method 100 begins anew with step S102 when the operator 11 starts a new task.

In other configurations some or all of the joints of the end-effector 50 may be actuated. That is, the articulated device 25 is capable of handling multiple different end-effectors 50 without having to change the base assembly 30. New end-effectors 50 with new kinematics are accounted for in logic of the controller 70 of FIGS. 1 and 1A automatically upon selection of a new task or end-effector 50. Using actuators at the joints of the end-effector 50 increases overall control complexity, but also provides the benefits of increased autonomy, possible force amplification at step S102, and a greater range of task load handling.

Certain performance requirements may be designed into the device 25 of FIGS. 1-3 to further enable interaction between the operator 11 and the device 25 in the performance of manipulation and assembly tasks. For practicality and other reasons, the device 25 can be designed to carry a payload of at least 9.1 kg/20 lbs, and to reach a maximum static force of 156 N or 35 lbs. The hand or wrist turn motions of the operator 11 required to reach the above-noted maximum static torque is less than 3 Nm in the same embodiment. Although omitted from the drawings for simplicity, a handle may be added to the device 25 to facilitate pushing, lifting, or twisting of the device 25 during manual positioning. To minimize the likelihood of interference with the operator 11, only the HMI of FIG. 1 and the end-effector 50 should occupy the reachable space of the operator 11. Likewise, the device 25 should be configured so as not to obstruct the view of the operator 11 of the work tool 20, and to be easily adjusted by the operator 11 whenever visibility of the task is occluded.

As noted above, the end-effector 50 may be of any 1 DOF+ design mounted to an existing actuated serial robot or manipulator to perform the same function. In other words, a multi-axis active serial robot (not shown) such as a 6-axis manufacturing robot acts as the base assembly 30. In such an embodiment, the robot would require the same range of motion as the base assembly 30 including the support structure 12, and the controller 70 would communicate with any joint actuators of such a robot in the same manner as described above. Another possible scenario is that multiple end-effectors 50 of 1 DOF+ passive and/or active design may be mounted to the same base assembly 30 or robot and used to grasp the work tool 20. In such an embodiment, the controller 70 may be programmed with multiple control options as set forth above with reference to FIG. 4.

The detailed description and drawings are supportive and descriptive of the disclosure, but the scope of the invention is defined solely by the claims. While some of the best modes and other embodiments for carrying out the claimed invention have been described in detail, various alternative designs and embodiments exist for practicing the disclosure as defined in the appended claims.

1. A system comprising:
a support structure;
a base assembly connected to the support structure and having a plurality of joints and a plurality of joint actuators, wherein the base assembly and the support structure collectively provide the system with at least three degrees of freedom (DOF);
an end-effector configured to grasp an object, connected in series with the base assembly, and having at least one additional joint providing the system with at least one additional DOF, wherein the base assembly and the end-effector are configured to support a task load associated with a manual work task involving the object, and wherein the task load includes at least one of a weight and a reaction torque of the object;
a plurality of sensors each operable to measure a position of a corresponding one of the plurality of joints and of the at least one additional joint; and
a controller in communication with the sensors and the joint actuators, wherein the controller is programmed to receive the measured positions from the sensors, generate a control output signal using the received measured positions, and transmit the control output signal to the joint actuators to thereby control the joint actuators in a manner sufficient for supporting the task load and extending a range of motion of the object with respect to the end-effector;
wherein at least one of the DOFs of the end-effector is redundant with at least one of the DOFs of the base assembly such that motion of the object in the redundant DOFs can be achieved by the base assembly or the end-effector.

2. The system of claim 1, wherein the base assembly includes a gantry or an overhead bridge having at least one rail and a trolley suspended from the at least one rail, and wherein the trolley is translatable with respect to an axis of the horizontal rail.

3. The system of claim 1, wherein the base assembly includes a frame constructed of a plurality of control arms and a control cylinder connected to the plurality of control arms, a first joint actuator of the plurality of joint actuators is positioned on or within the control cylinder and provides the frame with a rotational DOF, and a second joint actuator of the plurality of joint actuators provides the frame with a translational DOF in a vertical direction with respect to a longitudinal axis of the control cylinder.

4. The system of claim 3, wherein the plurality of control arms form a double parallelogram mechanism.

5. The system of claim 3, wherein the end-effector is connected to a distal end of the plurality of control arms and has a plurality of end-effector joints providing the system with at least three additional DOF, and wherein the end-effector is configured to grasp the object.

6. The system of claim 1, wherein the end-effector has three translational DOF and two rotational DOF.

7. The system of claim 6, wherein the end-effector includes three linear guide members and three carriages which engage and translate along a respective one of the three linear guide members to provide the three translational DOF.

8. The system of claim 1, wherein the controller includes a human machine interface (HMI) and is programmed with a plurality of control modes, and wherein the controller is configured to receive a mode selection as an input signal from the HMI to thereby select one of the plurality of control modes.

9. The system of claim 8, wherein the plurality of control modes includes at least one of a position control mode, a force control mode, an impedance control mode, and an admittance control mode.

10. The system of claim 9, wherein the plurality of control modes includes the force control mode, and wherein the force control mode includes a force amplification mode.

11. A method for assisting an operator in the performance of a manual assembly task using a system having a support structure, a base assembly connected to the support structure, and an end-effector connected in series with the base assembly, and having at least one additional joint providing the system with at least one additional DOF, wherein the base assembly includes a plurality of joints and a plurality of joint actuators, and wherein the base assembly and the support structure collectively provide the system with at least three degrees of freedom (DOF), wherein at least one of the DOFs of the end-effector is redundant with at least one of the DOFs of the base assembly such that motion of the object in the redundant DOFs can be achieved by the base assembly or the end-effector, the method comprising:
receiving, via a controller, measured position signals describing a position of a corresponding one of the plurality of joints and the at least one additional joint as the operator manually manipulates an object using the end-effector;
generating a control output signal via the controller using the received measured positions; and
transmitting the control output signal to the joint actuators to thereby control the joint actuators in a manner sufficient for supporting a task load of the object and extending a range of motion of the work tool with respect to the end-effector.

12. The method of claim 11, further comprising:
determining whether the measured position signals indicate that the operator has moved the end-effector from the initial position to a different position; and
transmitting output signals to the joint actuators to cause an offset or offloading of the task load when the movement of the end-effector is determined.

13. The method of claim 11, further comprising:
transmitting the control output signals to the joint actuators to maintain the end-effector at a desired equilibrium or balanced position as the operator performs the work task when the signals indicate that the operator has not moved the end-effector from the initial position to a different position.

14. The method of claim 11, further comprising:
identifying the end-effector needed for the manual work task; and
uploading kinematic equations of the selected end-effector into memory of the controller.

15. The method of claim 11, wherein the controller includes a human-machine interface, the method further comprising: selecting a control law via the human machine interface from a group consisting of a position control mode, a force control mode, an impedance control mode, and an admittance control mode.

16. The method of claim 5, including selecting the force control mode, wherein the force control mode includes a force amplification mode.
